(19) United States
(12) Patent Application Publication
(10) Pub. No.: US 2017/0328313 A1
(43) Pub. Date: Nov. 16, 2017

(54) EGR COOLER FOR VEHICLE

(71) Applicants: Hyundai Motor Company, Seoul (KR); Kia Motors Corporation, Seoul (KR)

(72) Inventors: Dong Ho CHU, Ansan-si (KR); Yong Hoon KIM, Seoul (KR); Yang Geol LEE, Hwaseong-si (KR); Young Bae YANG, Anseong-si (KR)

(73) Assignees: Hyundai Motor Company, Seoul (KR); Kia Motors Corporation, Seoul (KR)

(21) Appl. No.: 15/280,648

(22) Filed: Sep. 29, 2016

(30) Foreign Application Priority Data
May 11, 2016 (KR) 10-2016-0057576

(51) Int. Cl. F02M 26/32; F01P 5/10

(52) U.S. Cl. CPC F02M 26/32; F01P 5/10

(57) ABSTRACT

An EGR cooling system for a vehicle may include an EGR cooler having an inlet at a first side and an outlet at a second side thereof, in which a gas channel may be disposed between the inlet and the outlet for heat exchange with coolant in coolant channels, and the outlet may be connected to a water pump, in an engine having a separable cooling system that includes the coolant channels individually formed in each of an engine head and an engine block of the engine, to control the supply of coolant.

### CROSS REFERENCE TO RELATED APPLICATION

The present application claims priority to Korean Patent Application No. 10-2016-0057576, filed May 11, 2016, the entire contents of which is incorporated herein for all purposes by this reference.

### BACKGROUND OF THE INVENTION

### Field of the Invention

The present invention relates to an Exhaust Gas Recirculation (EGR) cooler, and more particularly, to an EGR cooler for a vehicle that is integrally inserted in an engine block and can restore exhaust heat by exchanging heat with coolant.

### Description of Related Art

An Exhaust Gas Recirculation (EGR) cooler reduces the temperature of an exhaust gas from a vehicle in a process of circulating the exhaust gas back to the intake system in the vehicle. The exhaust gas flowing in a cylinder through the EGR cooler and the intake manifold of an engine is burned again. Accordingly, the nitrogen oxides (NOx) in the exhaust gas are burned, so that the content of noxious substances in the exhaust gas finally discharged out of the vehicle can be minimized.

A common structure of EGR coolers includes a housing through which coolant can flow and a heat dissipation fin unit disposed in the housing and separated from a coolant channel. A high-temperature exhaust gas flows to the heat dissipation fin unit and coolant flows in the housing, and in this process, the coolant and the exhaust gas exchange heat with each other, so the exhaust gas increases in temperature and the coolant decreases in temperature.

However, in an engine equipped with a separable cooling system, when coolant is not supplied to the engine block, an EGR cooler is not cooled and a high-temperature EGR gas transfers to an EGR valve and is supplied back to the combustion chamber, thus not only leading to problems related to the durability of the EGR valve and the engine, but also failing to reduce nitrogen oxides (NOx) in the exhaust gas.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an EGR cooler for a vehicle that may be supplied with coolant even though coolant is not supplied to an engine block to improve fuel efficiency when an engine is equipped with separable cooling system.

According to various aspects of the present invention, an EGR cooling system for a vehicle may include an EGR cooler having an inlet at a first side and an outlet at a second side thereof, in which a gas channel may be disposed between the inlet and the outlet for heat exchange with coolant in coolant channels, and the outlet may be connected to a water pump, in an engine having a separable cooling system that includes the coolant channels individually formed in each of an engine head and an engine block of the engine, to control the supply of coolant.

The gas channel may be disposed at a predetermined inclination angle relative to the engine block such that the outlet may be positioned lower than the inlet.

A nipple extending upward may be disposed at a side of the inlet.

The gas channel may be inserted in the engine block.

An outlet pipe may be provided for coolant passing through the EGR cooler to be supplied back to the water pump to circulate the coolant.

The inlet for coolant flowing into the EGR cooler may be configured to be disposed in a coolant channel in the engine head, so the coolant may be supplied to the EGR cooler from the engine head even when flow of the coolant stops in the engine block.

According to the EGR cooler system for a vehicle having the configuration described above, a channel is provided for the supply of coolant to the engine cooler in the engine block from the engine head in the engine equipped with a separable cooling system, so it is possible to continuously cool the EGR cooler using the coolant from the engine head, even if the flow of coolant in the engine block is stopped.

Further, since the inlet of the EGR cooler is connected to the water pump, it is possible to increase cooling efficiency by increasing the performance of the EGR cooler using the high-speed flow of coolant at the front end of the water pump and it is also possible to quickly warm up the engine by supplying coolant that has exchanged heat through the EGR cooler.

Additionally, since the EGR cooler is combined with the engine block at a predetermined angle such that the outlet is positioned lower than the inlet, coolant can flow to the EGR cooler even if the engine is inclined, and bubbles are not formed in the coolant.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing an EGR cooler system for a vehicle according to various embodiments of the present invention.

FIG. 2 is a plan view of FIG. 1.

FIG. 3 is a view showing coolant channels of FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

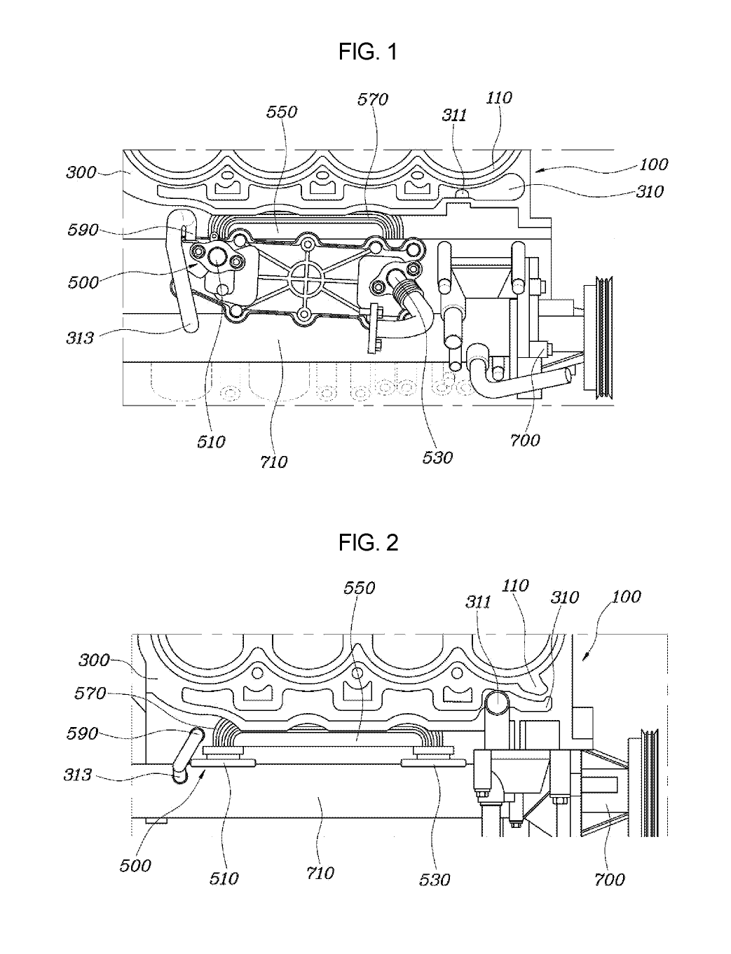

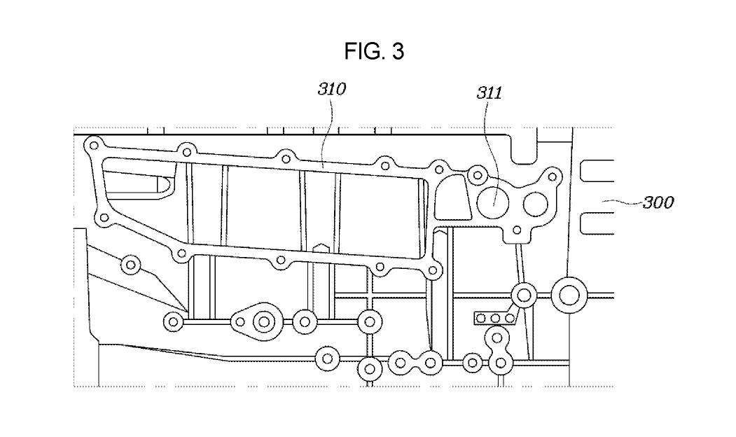

FIG. 1 is a view showing an EGR cooler system for a vehicle according to various embodiments of the present invention, FIG. 2 is a plan view of FIG. 1, and FIG. 3 is a view showing coolant channels of FIG. 1.

An EGR cooler system for a vehicle according to various embodiments of the present invention includes an EGR cooler 500 that has an inlet 510 at a side and an outlet 530 at another side and in which a gas channel 550 is disposed between the inlet 510 and the outlet 530 for heat exchange with coolant in coolant channels 110 and 310 and the outlet 530 is connected to a water pump 700, in an engine 100 having a separable cooling system that has the coolant channels 110 and 310 individually formed in an engine head and an engine block 300, respectively, to control the supply of coolant.

The inlet 311 for coolant to flow into the EGR cooler 500 is disposed in the coolant channel 110 of the engine head so that the coolant in the engine head is supplied to the EGR cooler 500 through the coolant inlet 311 in the coolant channel 110 of the engine head, even if the flow of coolant stops in the engine block 300. In particular, the gas channel 550 of the EGR cooler 500 may be inserted in the engine block 300 and positioned in the coolant channel 110.

Accordingly, even if the supply of coolant to the coolant channel 310 of the engine block 100 is limited to improve fuel efficiency, coolant is supplied to the EGR cooler 500 through the coolant inlet 311 in the coolant channel 110 of the engine head, so the EGR cooler 50 can be continuously supplied with coolant and can cool an EGR gas. Further, there is provided an output pipe 710 through which the coolant passing through the EGR cooler 500 can be supplied to a water pump 700, so the coolant from the water pump 700 is supplied back to the water pump 700 through the engine 100 and the EGR cooler 500, whereby the EGR gas in the EGR cooler 500 can be cooled and the coolant can circulate as well.

The outlet 530 of the EGR cooler 500 may be connected to the water pump 700. The reason is because flow of coolant is continuously made at the front end of the water pump 700 while the water pump 700 is operated. In particular, coolant flows at the front end of the water pump 700 at a higher speed than the coolant flowing in the engine block, so it is possible to increase the flow of the coolant flowing through the EGR cooler 500 in the engine block 300. Accordingly, it is possible to increase cooling efficiency by improving the performance of the EGR cooler 500, and the engine 100 can be quickly warmed up because it is supplied with the coolant that has exchanged heat through the EGR cooler 500. Further, the coolant and the EGR gas flow in opposite directions in order to increase the cooling efficiency by continuously changing the ranges where the coolant and the EGR gas meet each other.

The gas channel 550 of the EGR cooler 500 is inclined at a predetermined angle in the engine block 300 such that the outlet 530 is positioned lower than the inlet 510. Accordingly, even if the engine 100 is inclined while a vehicle runs, the coolant flowing in the inlet 510 is naturally moved to the outlet 530 by gravity after passing by the gas channel 550, so the EGR cooler 500 can be supplied with coolant without interference. Further, the gas channel 550 is inclined, as described above, and a coolant outlet 313 having a nipple 590 extending upward is disposed at a side of the inlet 510, so it is possible to remove bubbles formed in the coolant while the coolant flows, using the nipple 590. Furthermore, it is possible to prevent bubbles from forming when the EGR cooler 500 is supplied with coolant, thereby increasing the cooling efficiency. The EGR cooler 500 may be inclined at a predetermined angle relative to the engine block 300, for example, at 3 degrees. The EGR cooler 500 may be inclined at an angle more than 3 degrees if necessary depending on design considerations.

The flow of the EGR gas and the coolant is described hereafter. First, the EGR gas, which is an EGR gas collected from an exhaust gas flows into the inlet 510, exchanges heat with the coolant while flowing through the gas channel 550 having a plurality of heat dissipation fins 570, and then flows outside through the outlet 530, whereby the EGR gas is supplied back to the engine 100 with the temperature decreased.

The coolant is supplied to the engine 100 from the water pump 700, in which the coolant is separately supplied through the coolant channel 110 in the engine head and the coolant channel 310 in the engine block 300. Since the coolant inlet 311 is disposed in the coolant channel 110 in the engine head, coolant is supplied to the EGR cooler 500 through the coolant inlet 311, flows through the coolant outlet 313 having the nipple 590, and is supplied back to the water pump 700 through the outlet pipe 710, whereby the coolant circulates.

Therefore, according to the EGR cooler system for a vehicle, a channel is provided for the supply of coolant to the engine cooler 500 in the engine block 300 from the engine head in the engine 100 equipped with a separable cooling system, so it is possible to continuously cool the EGR cooler 500 using the coolant from the engine head, even if the flow of coolant stops in the engine block 300.

Further, since the inlet 510 of the EGR cooler 500 is connected to the water pump 700, it is possible to increase cooling efficiency by increasing the performance of the EGR cooler 500 using the high-speed flow of the coolant at the front end of the water pump 700 and it is also possible to quickly warm up the engine by supplying the coolant that has exchanged heat through the EGR cooler 500.

Furthermore, since the EGR cooler 500 is combined with the engine block 300 at a predetermined angle such that the outlet 530 is positioned lower than the inlet 510, coolant may flow to the EGR cooler 500 even if the engine 100 is inclined, and bubbles are not formed in the coolant.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An EGR cooler system for a vehicle, comprising an EGR cooler having an inlet at a first side and an outlet at a second side thereof, wherein a gas channel is disposed between the inlet and the outlet for heat exchange with coolant in coolant channels, and the outlet is connected to a water pump, in an engine having a separable cooling system that includes the coolant channels individually formed in each of an engine head and an engine block of the engine, to control the supply of coolant.

2. The EGR cooler system of claim 1, wherein the gas channel is disposed at a predetermined inclination angle relative to the engine block such that the outlet is positioned lower than the inlet.

3. The EGR cooler system of claim 1, wherein a nipple extending upward is disposed at a side of the inlet.

4. The EGR cooler system of claim 1, wherein the gas channel is inserted in the engine block.

5. The EGR cooler system of claim 1, wherein an outlet pipe is provided for coolant passing through the EGR cooler to be supplied back to the water pump to circulate the coolant.

6. The EGR cooler system of claim 1, wherein the inlet for coolant flowing into the EGR cooler is disposed in a coolant channel in the engine head, so the coolant is supplied to the EGR cooler from the engine head even when flow of the coolant stops in the engine block.
